(19) United States
(12) Patent Application Publication
(10) Pub. No.: US 2019/0244128 A1
(43) Pub. Date: Aug. 8, 2019

(54) QUANTUM CIRCUIT AND METHOD FOR IMPLEMENTING HETEROGENEOUSLY ENCODED LOGICAL BELL STATE

(71) Applicant: ELECTRONICS AND TELECOMMUNICATIONS RESEARCH INSTITUTE, Daejeon (KR)

(72) Inventors: Byung-Soo CHOI, Daejeon (KR); Yong-Soo HWANG, Daejeon (KR)

(21) Appl. No.: 16/343,374

(22) PCT Filed: Oct. 17, 2017
(86) PCT No.: PCT/KR2017/011470

§ 371 Date: Apr. 18, 2019

(30) Foreign Application Priority Data
Oct. 18, 2016 (KR) 10-2016-0135303
Jun. 23, 2017 (KR) 10-2017-0079978

(51) Int. Cl. G06N 10/00

(52) U.S. Cl. CPC G06N 10/00

(57) ABSTRACT

Provided is a quantum circuit for implementing a heterogeneously encoded logical Bell state encoded including a Hadamard gating circuit configured to perform Hadamard conversions on a cat state, a controlled-NOT gating circuit configured to perform CNOT operations on first and second logical qubits and conversion results of the Hadamard gating circuit, a measuring circuit configured to measure calculation results of the CNOT gating circuit, and a logical bit converter configured to convert a bit of the second logical qubit on a basis of the measured result of the measuring circuit.

### CROSS-REFERENCE TO RELATED APPLICATIONS

This application claims priority under 35 U.S.C. § 119 of Korean Patent Application Nos. 10-2016-0135303, filed on Oct. 18, 2016, and 10-2017-0079978, filed on Jun. 23, 2017, the entire contents of which are hereby incorporated by reference.

### BACKGROUND

The present disclosure herein relates to quantum computing, and more particularly, to a quantum circuit and method for implementing a heterogeneously encoded logical Bell state encoded with two different quantum error correction codes.

A quantum computer, based on qubits that are represented as a superposition of ‘0’ and ‘1’ using a principle of quantum mechanics, is known for performing a faster operation than a digital computer that handles bits capable of representing only ‘0’ or ‘1’. As a representative example showing excellent performance of a quantum computer, there is an integer factorization and a quantum mechanics simulation, etc. There are lots of attempts to implement a quantum computer using quantum mechanics, but it is very difficult to practically implement the quantum computer. A quantum noise issue is a representative example of the difficulty. A unique state that is inherent in quantum information may be easily lost by a small quantum noise. Therefore, fault-tolerant quantum error correction is used using a quantum error correction code for protecting the quantum information.

The fault-tolerant quantum information processing indicates that quantum information is encoded using a quantum error correction code and then the quantum information is operated using a quantum operator operating fault-tolerantly. Here, “fault-tolerant” means that even though a noise below a certain level occurs during information processing, the noise does not influence a final information processing result. The quantum information may be protected from the noise using the fault-tolerant quantum information processing based on the quantum error correction code.

On the other hand, the quantum computer may be configured of a plurality of components performing various functions. For example, there are a CPU for processing quantum information, a memory for storing the quantum information, and a bus for delivering information between the CPU and memory, etc. As currently known, since various quantum technologies have different characteristics and various quantum computer components have different functions and characteristics, it is necessary to combine the various quantum technologies for implementing a quantum computer.

Besides, quantum error correction codes having been suggested until now have different characteristics. Accordingly, for various purposes of quantum information processing in the quantum computer, it may be more effective to use multiple quantum error correction codes in combination, rather than a single quantum error correction code. In order to use various quantum error correction codes, it is essential to mutually convert different quantum error correction codes. A representative method thereof is a code teleportation. Using the code teleportation, pieces of quantum information encoded with different quantum error correction codes may be mutually converted into each other.

Until now, it has been suggested various quantum information processing protocols using the code teleportation. In order to use the code teleportation, a heterogeneously encoded logical Bell state is required in which encoding has been performed with two different quantum error correction codes desired to perform a conversion. However, a detailed method for implementing the heterogeneously encoded logical Bell state has rarely been discussed. Accordingly, in order to practically use the code teleportation, it is very important to implement the heterogeneously encoded logical Bell state.

### SUMMARY

The present disclosure provides a quantum circuit and method for implementing logical Bell states, which enable a mutual conversion between pieces of quantum information encoded by different quantum error correction codes.

An embodiment of the inventive concept provides a quantum circuit including: a Hadamard gating circuit configured to perform Hadamard conversions on a cat state; a controlled-NOT (CNOT) gating circuit configured to perform CNOT operations on first and second logical qubits encoded by first and second quantum error correction codes, respectively, and conversion results of the Hadamard gating circuit; a measuring circuit configured to measure calculation results of the CNOT gating circuit; and a logical bit converter configured to convert a bit of the second logical qubit on a basis of the measured result of the measuring circuit.

In an embodiments of the inventive concept, a method of operating a quantum circuit configured to a logical Bell state heterogeneously encoded by different quantum error correction codes, including: performing a Hadamard conversion on cat states; performing CNOT operations on a result of the Hadamard conversion and first and second logical qubits encoded by first and second quantum error correction codes, respectively; measuring results of the CNOT operations; and performing a conversion on a bit of the second logical qubit on a basis of the measured results.

In an embodiments of the inventive concept, a quantum circuit includes: first to third quantum circuits, each of which comprises a Hadamard gating circuit configured to perform Hadamard conversions on cat states, a CNOT gating circuit configured to perform CNOT operations on first and second logical qubits encoded by first and second quantum error correction codes, respectively, and conversion results of the Hadamard gating circuit, and a measuring circuit configured to measure calculation results of the CNOT gating circuit; a selection circuit configured to receive a measured result of the measuring circuit of each of the quantum circuits and select a target quantum state; and a logical bit converter configured to convert a bit of the second logical qubit output from the third quantum circuit on a basis of the selection result of the selection circuit.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram schematically showing a quantum circuit according to an embodiment of the present inventive concept;

FIG. 2 shows in detail a configuration of the quantum circuit illustrated in FIG. 1;

FIG. 3 is a block diagram exemplarily showing a quantum circuit according to an embodiment of the present inventive concept;

FIG. 4 schematically shows a code teleportation circuit using an

Eistein-Podolsky-Rose (EPR) pair generated by a quantum circuit according to an embodiment of the present inventive concept;

FIG. 5 schematically shows a state injection circuit; and

FIG. 6 is a block diagram exemplarily showing a quantum circuit according to an embodiment of the present inventive concept.

### DETAILED DESCRIPTION

Hereinafter, an exemplary embodiment of the present disclosure will be described in detail with reference to the accompanying drawings such that a person skilled in the art may easily carry out the embodiments of the present disclosure.

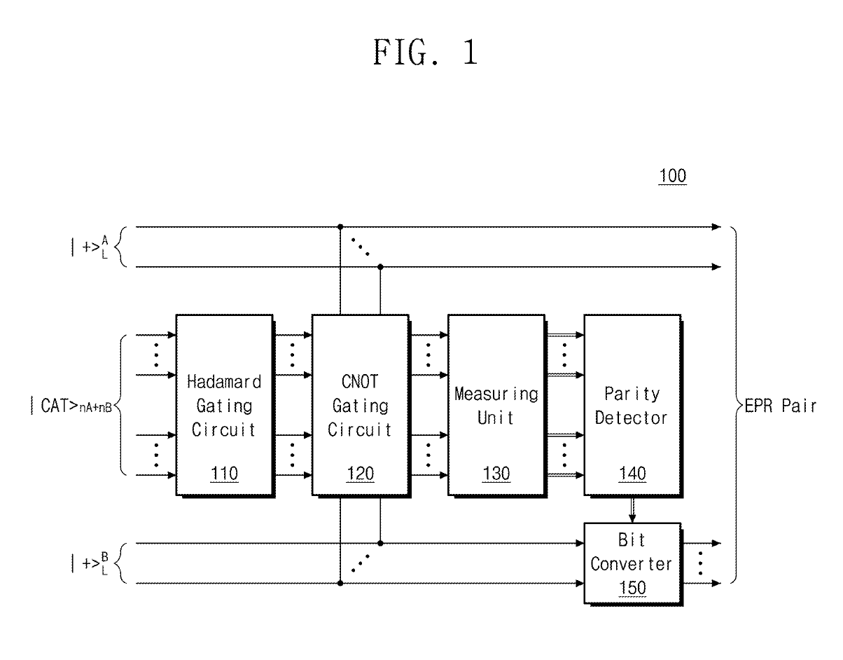

FIG. 1 is a block diagram schematically showing a quantum circuit according to an embodiment of the present inventive concept. Referring to FIG. 1, a quantum circuit 100 may include a Hadamard gating circuit 110, a controlled-NOT (CNOT) circuit 120, a measuring unit 130, a parity detector 140, and a logical bit converter 150.

The quantum circuit 100 may generate a logical Bell state essentially required for code teleportation that enables a mutual conversion between pieces of quantum information encoded by different quantum error correction codes. For example, a physical Bell state may mean a quantum state in which two qubits are maximally entangled, and a logical Bell state may mean a quantum state in which each of two qubits in a physical Bell state is encoded with a quantum error correction code. In addition, a heterogeneously encoded logical Bell state proposed in the present inventive concept may mean a logical Bell state in which two qubits in a physical Bell state are respectively encoded using different quantum error correction codes. For example, the quantum circuit 100 may generate an Eistein-Podolsky-Rose (EPR) pair as a logical Bell state.

The quantum circuit 100 may receive a cat state having the length of nA+nB. For example, the cat state received by the quantum circuit may be defined as the following Equation (1).

|CAT>_{nA+nB}=|0>^{⊗nA}|0<^{⊗nB}+|1>^{⊗nA}|1>^{⊗nB} (1)

where, nA is the block size of quantum error correction code A and nB is the block size of quantum error correction code B.

The Hadamard gating circuit 110 may be configured to perform a Hadamard conversion on the received cat state. For example, the Hadamard gating circuit 110 may be configured to convert an individual qubit |0> or |1> in the cat state into a superposed state of a base state |0> or |1>. For example, the Hadamard gating circuit 110 may be configured to perform the following Equations (2) and (3). In Equations (2) and (3), a subscript ‘H’ over arrows indicates Hadamard conversion.

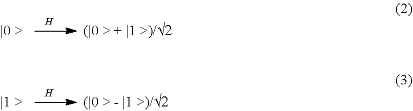

The quantum circuit 100 may receive logical qubits encoded by different error correction codes. For example, the quantum circuit 100 may receive a logical qubit |+>_{L}^{A}=(|0>_{L}^{A}+|1>_{L}^{A})/\sqrt{2} (or a positive quantum state) encoded by quantum error correction code A, and a logical qubit (or a positive quantum state) encoded by quantum error correction code B.

The CNOT gating circuit 120 may perform CNOT operation on an output result of the Hadamard gating circuit 110 and logical qubits |+>_{L}^{A}, |+>_{L}^{B}. The CNOT gating circuit 120 may receive two qubits and output two output qubits, and calculates to convert one state of the received qubits according to the other state. For example, a first qubit of the received qubits may be a condition qubit C and a second qubit may be a target qubit T. For example, when the condition qubit is ‘0’, the CNOT gating circuit 120 may maintain the input of the target qubit without a change. On the contrary, when the condition qubit is ‘1’, the CNOT gating circuit 120 may perform a conversion on the input of the target qubit. The following table 1 represents a truth table of the CNOT gating circuit 120.

TABLE 1

| | |
|---|---|
| Input | Output |

| C | T | C | T |
|---|---|---|---|
| 0 | 0 | 0 | 0 |
| 0 | 1 | 0 | 1 |
| 1 | 0 | 1 | 0 |
| 1 | 1 | 1 | 1 |

For example, by the CNOT gating circuit 120, a CNOT operation may be performed in a qubit unit for some qubits corresponding to a logical qubit |+>_{L}^{A} and code A of cat state |CAT>_{nA+nB}, and a CNOT operation may be performed in a qubit unit for the remaining qubits corresponding to a logical qubit |+>_{L}^{B} and code B of cat state|CAT>_{nA+nB}.

The measuring unit 130 may measure the calculation result of the CNOT gating circuit 120 and output a classical bit (i.e. 0 or 1) according to the measured result. Signals in the drawing, which are output from the measuring unit 130, may represent classical bits and each arrow is represented with two lines. This is for distinguishing from an arrow with one line, which represents a qubit flow. For example, since the CNOT gating circuit 120 is executed in a qubit unit, an output of the CNOT gating circuit 120 may be configured of a combination of |0>_{L}^{A}|0>_{L}^{B}, |0>_{L}^{A}|1>_{L}^{B}, |1>_{L}^{A}|1>_{L}^{B}, and |1>_{L}^{A}|0>_{L}^{B}.

For example, the measuring unit 130 may measure a bit value of ‘0’ or ‘1’ of a qubit output from the CNOT gating circuit 120.

The parity detector 140 may receive an output result of the measuring unit 130 to calculate a parity. For example, by the parity detector 140, when the number of ‘1’ of classical bits received from the measuring unit 130 is determined as an odd number, an additional calculation may be performed on a logical qubit |+>_{L}^{B} by the logical bit converter 150. On the contrary, by the parity detector 140, when the number of ‘1’ of classical bits received from the measuring unit 130 is determined as an even number, an additional calculation may be not performed by the logical bit converter 150.

The logical bit converter 150 may perform a conversion on a bit of a logical qubit |+>_{L}^{B}. For example, when the number of ‘1 ’ of classical bits received from the measuring unit 130 is an odd number, the logical bit converter 150 may reverse a bit of the logical qubit |+>_{L}^{B}. In Equation X_{L}^{B}=Πσₓⁱ, the physical bit converter σₓⁱ represents performing a bit flip of using a Pauli matrix

$${σ}_{x} = [ \begin{matrix}0 & 1 \\ 1 & 0\end{matrix} ]$$

on a physical qubit i, which has a meaning like executing an X operation.

When all the process including the conversion by the logical bit converter 150 is completed, a heterogeneously encoded logical Bell state of an entangled state (i.e. an EPR pair in an entangled state) |0>_{L}^{A}|0>_{L}^{B}+|1>_{L}^{A}|1>_{L}^{B} may be generated.

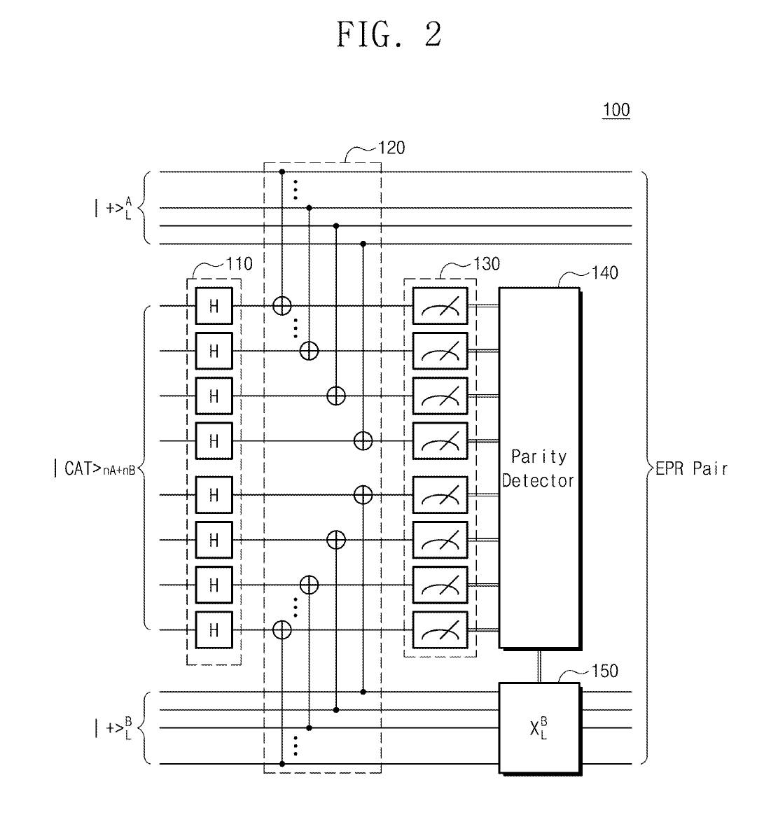

FIG. 2 shows in detail a configuration of the quantum circuit illustrated in FIG. 1.

The Hadamard gating circuit 110 may include a plurality of Hadamard gates. For example, the Hadamard gating circuit 110 may include the proper number of Hadamard gates so that a CNOT operation is performed on each qubit and logical qubits |+>_{L}^{A},|+>_{L}^{B} configuring the cat state.

The CNOT gating circuit 120 may include a plurality of CNOT gates. Similarly, the CNOT gating circuit 120 may include the proper number of CNOT gates so that a CNOT operation is performed on each qubit and logical qubits |+>_{L}^{A},|+>_{L}^{B} configuring the cat state.

The measuring unit 130 may measure an output result of each CNOT gate configuring the CNOT gating circuit 120. For this end, the measuring unit 130 may include measuring elements configured to measure an output result of each CNOT gate. For example, each measuring element configuring the measuring unit 130 may measure a calculation result of the CNOT gate to output the same as a classical bit ‘0’ or ‘1’.

The parity detector 140 may determine whether an additional calculation is necessary for a qubit |+>_{L}^{B}. For example, when the number of ‘1’ of classical bits received from the measuring unit 130 is an odd number, the parity detector 140 may control a logical bit converter 150 so that an additional calculation is performed on a logical qubit |+>_{L}^{B}.

The logical bit converter 150 may reverse the bit of the logical qubit |+>_{L}^{B} on the basis of the determination result of the parity detector 140. For example, the logical bit converter 150 may be configured of a combination of a plurality of physical bit converters, and the combination may be differed according to a used quantum error correction code. In Equation X_{L}^{B}=Πσₓⁱ, the physical bit converter σₓⁱ represents performing a bit flip of using a Pauli matrix

$${σ}_{X} = [ \begin{matrix}0 & 1 \\ 1 & 0\end{matrix} ]$$

on a physical qubit i, which has a meaning like executing an X operation. However, since the logical qubit |+>_{L}^{B} is ‘logically’ encoded by the quantum error correction code ‘B’, the logical bit converter 150 is shown as X_{L}^{B}.

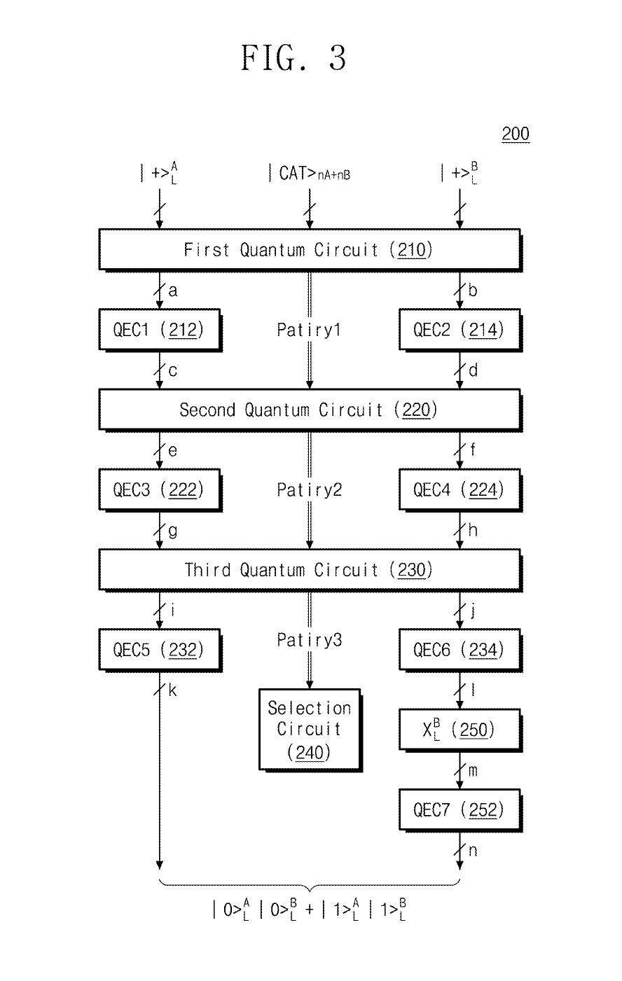

However, the quantum circuit having been described in relation to FIGS. 1 and 2 is not fault-tolerant. In other words, it is not ensured that an EPR pair output from the quantum circuit 100 is always |0>_{L}^{A}|0>_{L}^{B}+|1>_{L}^{A}|1>_{L}^{B}. The fault-tolerant quantum circuit will be described in detail in relation to FIG. 3.

FIG. 3 is a block diagram exemplarily showing a quantum circuit according to an embodiment of the present inventive concept. Unlike the quantum circuit 100 having been described in relation to FIGS. 1 and 2, a quantum circuit 200 may be fault-tolerant. For example, logical qubits |+>_{L}^{A},|>_{L}^{B}, the cat state, and the EPR pair input to the quantum circuit 100 of FIG. 1 are known quantum states in themselves. However, when the logical qubits |+>_{L}^{A},|+>_{L}^{B} input to the quantum circuit 100 and cat state have an error or a quantum state of the EPR pair output from the quantum circuit 100 is not a desired state, it means there is an error. Accordingly, in this case, when the error of the logic qubits |+>_{L}^{A},|+>_{L}^{B} input to the quantum circuit is corrected, or a cat state input to the quantum circuit is newly provided, an EPR pair without an error may be generated.

The quantum circuit 200 is substantially identical to the quantum circuit 100 having been described in relation to FIGS. 1 and 2. However, the quantum circuit 200 is configured of multi-stages. For example, the quantum circuit 200 may include a plurality of quantum circuits 210, 220, and 230. The quantum circuit 200 may include quantum error correction circuits (QECs) 212, 214, 222, 224, 232, 234, and 252. The quantum circuit 200 may receive parities respectively from the quantum circuits 210, 220, and 230, and include a selection circuit 240 for determining whether to perform an additional calculation on the logical qubit |+>_{L}^{B} according to the received parities. The quantum circuit 200 may include a bit converter 250 for performing an additional calculation on the logical qubit |+>_{L}^{B} according according to the determination result.

Each of the quantum circuits 210, 220, and 230 may include the Hadamard gating circuit 110, the CNOT gating circuit 120, the measuring unit 130, and the parity detector 140 having been described above in relation to FIGS. 1 and 2. However, each of the quantum circuits 210, 220, and 230 may not include the logical bit converter 150 illustrated in FIGS. 1 and 2.

The first quantum circuit 210 may receive logical qubits |+>_{L}^{A},|+>_{L}^{B} and a cat state, and perform a series of operations such as a Hadamard conversion, CNOT gating operation, measurement, and parity calculation. Descriptions thereabout have been provided in relation to FIGS. 1 and 2, and thus a detailed description will be omitted.

Parity 1 output from the first quantum circuit 210 may be delivered to the selection circuit 240. Even though it is illustrated in the drawing that parity 1 is delivered to the second quantum circuit 220, this is for clearness/simplification of the drawing. Logical qubits (shown as a and b in the drawing) output form the first quantum circuit 210 may have an error or not. Accordingly, the quantum error correction circuits 212 and 214 may perform a quantum error correction on the logic qubits (shown as a and b in the drawing) output from the first quantum circuit 210. Quantum states of the logical qubits may be stabilized by the quantum error correction operation.

The second quantum circuit 220 may receive logical qubits (shown as c and d in the drawing) and a cat state from the quantum error correction circuits 212 and 214, and perform a series of operations such as a Hadamard conversion, CNOT gating operation, measurement, and parity calculation.

Parity 2 output from the second quantum circuit 220 may be delivered to the selection circuit 240. Even though it is illustrated in the drawing that parity 2 is delivered to the third quantum circuit 230, this is for clearness/simplification of the drawing. Logical qubits (shown as e and f in the drawing) output from the second quantum circuit 220 may have an error or not. Accordingly, the quantum error correction circuits 222 and 224 may perform a quantum error correction on the logic qubits (shown as e and fin the drawing) output from the second quantum circuit 220. Quantum states of the logical qubits may be stabilized by the quantum error correction operation.

The third quantum circuit 230 may receive logical qubits (shown as g and h in the drawing) and a cat state from the quantum error correction circuits 222 and 224, and perform a series of operations such as a Hadamard conversion, CNOT gating operation, measurement, and parity calculation.

Parity 3 output from the third quantum circuit 230 may be delivered to the selection circuit 240. Logical qubits (shown as i and j in the drawing) output form the third quantum circuit 230 may have an error or not. Accordingly, the quantum error correction circuits 232 and 234 may perform a quantum error correction on the logic qubits (shown as i and j in the drawing) output from the third quantum circuit 230. Quantum states of the logical qubits may be stabilized by the quantum error correction operation.

The selection circuit 240 may select a desired state (i.e. a target quantum state) having a quantum state without an error with reference to parity 1, parity 2, and parity 3 respectively received from the quantum circuits 210, 220, and 230. For example, when parity 1, parity 2, and parity 3 coincide with each other, this means that there is not an error in the calculation result by each of the quantum circuits 210, 220, and 230. On the contrary, when two of parity 1, parity 2, and parity 3 coincide with each other and the remaining one is different, this means that there is not an error in calculation operations by the two quantum circuits that output the two parities having the coincident values. In other words, a proper parity value may be selected by majority voting like this.

When the proper parity value is selected by the selection circuit 240, the logical bit converter 250 may perform an additional calculation. However, whether to perform the additional calculation may depend on the selected parity value, and since this has been described in detail in relation to FIGS. 1 and 2, a description thereabout will be omitted.

The logical bit converter 250 may reverse a bit of the logical qubit (shown as i in the drawing) output from the quantum error correction circuit 234. The bit-reversed logical qubit (indicated as m in the drawing) may be delivered to the quantum error correction circuit 252.

The quantum error correction circuit 252 may perform quantum error correction on the logical cubit (shown as m in the drawing) and as a result, a quantum state of the logical qubit may be stabilized.

As a result, the logical qubits output from the quantum error correction circuits 232 and 252 may be a fault-tolerant logical Bell state (i.e. an entangled EPR pair) |0>_{L}^{A}|0>_{L}^{B}+|1>_{L}^{A}|1>_{L}^{B}.

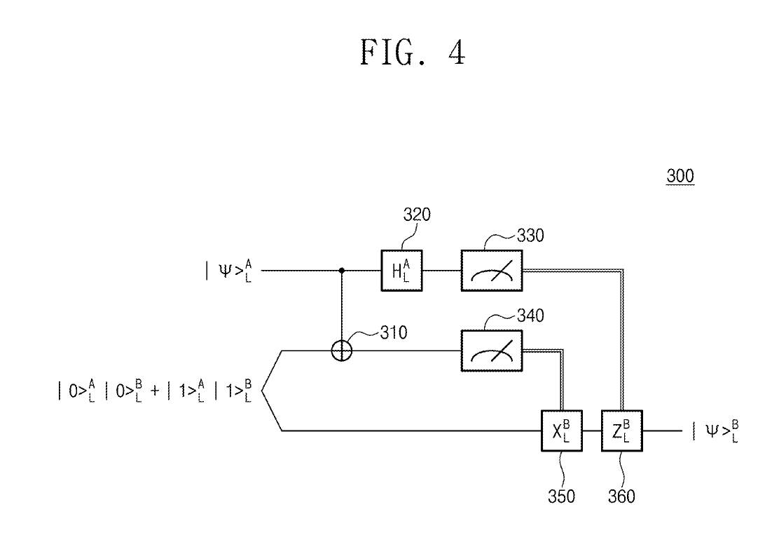

FIG. 4 schematically shows a code teleportation circuit using an EPR pair generated by a quantum circuit according to an embodiment of the present inventive concept. A code teleportation circuit 300 may include a CNOT gate 310, a Hadamard gate 320, a first measuring unit 330, a second measuring unit 340, a first logical bit converter 350, and a second logical bit converter 360.

The code teleportation circuit 300 may convert quantum information |ψ>_{L}^{A} encoded with quantum error correction code A into quantum information |ψ>_{L}^{B} encoded with quantum error correction code B.

First, the code teleportation circuit 300 may perform a CNOT operation on the EPR pair |0>_{L}^{A}|0>_{L}^{B}+|1>_{L}^{A}|1>_{L}^{B} and the quantum information |ψ>_{L}^{A} output from FIGS. 1 and 3.

The Hadamard gate 320 may perform a Hadamard conversion on the received quantum information |ψ>_{L}^{A}. The Hadamard conversion may be performed according to the above-described Equations (2) and (3).

The first measuring unit 330 may measure an output result of the Hadamard gate 320. For example, when the number of classical bits ‘1’ is an odd number among the output results of the Hadamard gate 320, the first measuring unit 330 may output logical qubit ‘1’. On the contrary, when the number of classical bits ‘1’ is an even number among the output results of the Hadamard gate 320, the first measuring unit 330 may output logical qubit ‘0’.

The second measuring unit 340 may measure an output result of the CNOT gate 310. For example, when the number of classical bits ‘1’ is an odd number among the output results of the CNOT gate 310, the second measuring unit 340 may output logical qubit ‘1’. On the contrary, when the number of classical bits ‘1’ is an even number among the output results of the CNOT gate 310, the second measuring unit 340 may output logical qubit ‘0’.

The first logical bit converter 350 may perform an additional calculation in dependence of an output result from the second measuring unit 340. For example, when a logical qubit output from the second measuring unit 340 is ‘1’, the first logical bit converter 350 may perform a logical bit conversion on a logical qubit corresponding to code B of the EPR pair |0>_{L}^{A}|0>_{L}^{B}+|1>_{L}^{A}|1>_{L}^{B}. This may be similar to operation of the logical bit converter 150 having been described in relation to FIGS. 1 and 2, or an operation of the logical bit converter 250 having been described in relation to FIG. 3.

The second logical bit converter 360 may perform an additional calculation in dependence of an output result from the second measuring unit 330. For example, when a logical qubit output from the first measuring unit 330 is ‘1’, the second logical bit converter 360 may perform a logical bit conversion on an output result of the first logical bit converter 350.

As a result, quantum information ★ψ>ₗ^{B} encoded with quantum error correction code B may be output from the second logical bit converter 360.

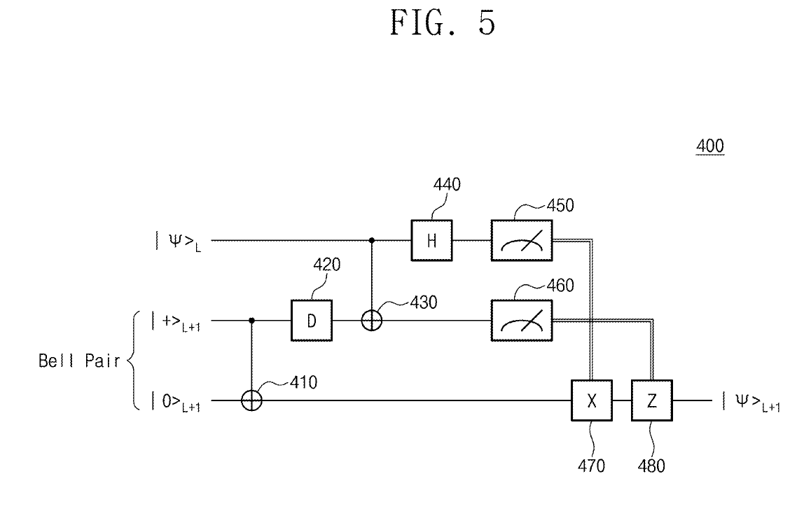

FIG. 5 schematically shows a state injection circuit for converting quantum information |ψ>_{L} encoded in a concatenation level L into quantum information |ψ>_{L+1} in the concatenation level L+1.

The state injection circuit 400 may include a first CNOT gate 410, a decoder 420, a second CNOT gate 430, a Hadamard gate 440, a first measuring unit 450, a second measuring unit 460, a first logical bit converter 470, and a second logical bit converter 480.

The first CNOT gate 410 may perform a CNOT operation on logical qubits |+>_{L+1} and |0>_{L+1}. The decoder 420 may decode the logical qubit |+>_{L+1} to generate a logical qubit in a concatenation level L. The second CNOT gate 430 may perform a CNOT operation on quantum information |ψ>_{L} and the logical qubit |+>_{L}. The Hadamard gate 440 may perform a Hadamard conversion on the quantum information |ψ>_{L}.

The first measuring unit 450 may measure a logical bit value of an output from the Hadamard gate 440. For example, when the number of classical bits ‘1’ is an odd number among the output results of the Hadamard gate 440, the first measuring unit 450 will output logical qubit ‘1’. The second measuring unit 460 may measure a logical bit value of an output from the second CNOT gate 430. For example, when the number of classical bits ‘1’ is an odd number among the output results of the second CNOT gate 430, the second measuring unit 460 will output logical qubit ‘1’.

The first logical bit converter 470 may perform an additional calculation in dependence of an output result from the first measuring unit 450. For example, when a logical qubit output from the second measuring unit 450 is ‘1’, the first logical bit converter 470 may perform a logical bit conversion on a third logical qubit in the drawing. This may be similar to an operation of the logical bit converter 150 having been described in relation to FIGS. 1 and 2, or an operation of the logical bit converter 250 having been described in relation to FIG. 3.

The second logical bit converter 480 may perform an additional calculation in dependence of an output result from the second measuring unit 460. For example, when a logical qubit output from the first measuring unit 460 is ‘1’, the second logical bit converter 480 may perform a logical bit conversion on an output result of the first logical bit converter 470.

As a result, quantum information |ψ>_{L+1} in a recursive (L+1)-th step may be generated.

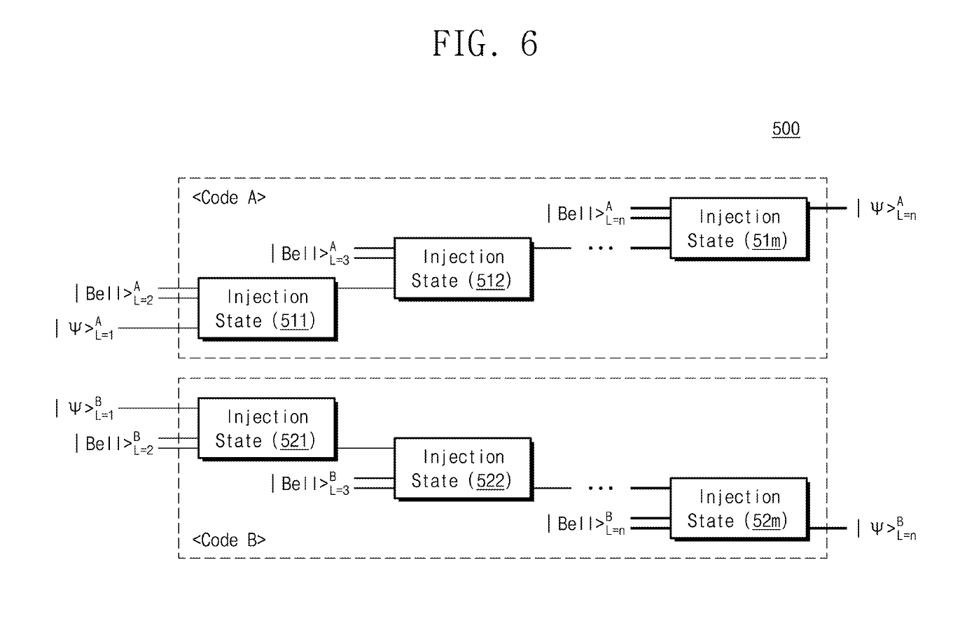

FIG. 6 is a block diagram exemplarily showing a quantum circuit according to an embodiment of the present inventive concept. A quantum circuit 500 may implement a heterogeneously logical Bell state encoded in an arbitrary concatenation level (i.e. n-th step).

The quantum circuit 500 may include a plurality of state injection circuits 511 to 51m and 521 to 52m. The state injection circuits 511 to 51m and 521 to 52m are substantially identical to that having been described in relation FIG. 5. Therefore repeated descriptions will be omitted.

The state injection circuits 511 to 51m may be configured to convert quantum information |ω>_{L=1}^{A} of a recursive first step, which is encoded with quantum error correction code A, into quantum information |ω>_{L=n}^{A} of a recursive n-th step. Similarly, the state injection circuits 521 to 52m may be configured to convert quantum information |ψ>_{L=1}^{B} of a recursive first step encoded with quantum error correction code A into quantum information |ω>_{L=n}^{B} of a recursive n-th step.

According to embodiments described above, pieces of quantum information encoded with different quantum error correction codes may be mutually freely converted. Since a general purpose information processing equipment (e.g. a quantum computer etc.) performs various functions, the equipment may be configured of a plurality of components. Accordingly, it may be easier to implement the general purpose information processing equipment using a quantum code conversion technology according to an embodiment of the present inventive concept.

According to an embodiment of the present inventive concept, a quantum circuit and method for implementing a logical Bell state may be provided, which enable mutual conversion between pieces of quantum information encoded with different quantum error correction codes.

The foregoing description is about detailed examples for practicing the inventive concept. The present disclosure includes not only the above-described embodiments but also simply changed or easily modified embodiments. In addition, the inventive concept may also include technologies obtained by easily modifying and practicing the above-described embodiments.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A quantum circuit comprising:
a Hadamard gating circuit configured to perform Hadamard conversions on a cat state;
a controlled-NOT (CNOT) gating circuit configured to perform CNOT operations on first and second logical qubits encoded by first and second quantum error correction codes, respectively, and conversion results of the Hadamard gating circuit;
a measuring circuit configured to measure calculation results of the CNOT gating circuit; and
a logical bit converter configured to convert a bit of the second logical qubit on a basis of the measured result of the measuring circuit.

2. The quantum circuit of claim 1, wherein a length of the cat state is equal to a sum of a length of the first logical qubit and a length of the second logical qubit.

3. The quantum circuit of claim 1, wherein the CNOT gating circuit performs CNOT operations on the first logical qubit and a quantum state, which corresponds to the first logical qubit, of the cat state, and
the CNOT gating circuit performs CNOT operations on the second logical qubit and a quantum state, which corresponds to the second logical qubit, of the cat state.

4. The quantum circuit of claim 1, wherein the first and second logical qubits are encoded to quantum state |+>_{L}.

5. The quantum circuit of claim 1, wherein the logical bit converter is configured of a Pauli X matrix or a combination of Pauli X matrices and reverses a bit of the second logical qubit.

6. The quantum circuit of claim 5, wherein the measuring circuit outputs classical bits corresponding to the calculation results of the CNOT gating circuit, and
the logical bit converter reverses the bit of the second logical qubit, when a number of ‘1’ of the classical bits is an odd number.

7. The quantum circuit of claim 6, further comprising:
a parity detector configured to determine whether to reverse the bit of the second logical qubit on a basis of the classical bits.

8. A method of operating a quantum circuit configured to a logical Bell state heterogeneously encoded by different quantum error correction codes, the operation method comprising:
performing a Hadamard conversion on cat states;
performing CNOT operations on a result of the Hadamard conversion and first and second logical qubits encoded by first and second quantum error correction codes, respectively;
measuring results of the CNOT operations; and
performing a conversion on a bit of the second logical qubit on a basis of the measured results.

9. The method of claim 8, wherein the performing of the conversion comprises reversing the bit of the second logical qubit using a Pauli X matrix or a combination of Pauli X matrices.

10. The method of claim 8, wherein the measuring comprises measuring the calculation result to output classical bits,
wherein, when a number of ‘1’ of the classical bits is an odd number, the bit of the second logical qubit is reversed.

11. A quantum circuit comprising:
first to third quantum circuits, each of which comprises:
a Hadamard gating circuit configured to perform Hadamard conversions on cat states;
a CNOT gating circuit configured to perform CNOT operations on first and second logical qubits encoded by first and second quantum error correction codes, respectively, and conversion results of the Hadamard gating circuit; and
a measuring circuit configured to measure calculation results of the CNOT gating circuit;
a selection circuit configured to receive a measured result of the measuring circuit of each of the quantum circuits and select a target quantum state; and
a logical bit converter configured to convert a bit of the second logical qubit output from the third quantum circuit on a basis of the selection result of the selection circuit.

12. The quantum circuit of claim 11, wherein the CNOT gating circuit of each of the quantum circuits performs CNOT operations on the first logical qubit and a quantum state, which corresponds to the first logical qubit, of the cat state, and
the CNOT gating circuit of each of the quantum circuits performs CNOT operations on the second logical qubit and a quantum state, which corresponds to the second logical qubit, of the cat state.

13. The quantum circuit of claim 11, wherein the selection circuit selects the target quantum state according to majority voting.

14. The quantum circuit of claim 11, further comprising:
a plurality of quantum error correction circuits configured to perform quantum error correction operations on the first and second quantum error correction codes output from each of the quantum circuits.

15. The quantum circuit of claim 11, wherein the first and second logical qubits input to each of the quantum circuits are encoded to quantum state |+>.

16. The quantum circuit of claim 11, wherein the logical bit converter reverses a bit of the second logical qubit output from the third quantum circuit using a Pauli X matrix or a combination of Pauli X matrices.
